(19) United States
(12) Patent Application Publication
(10) Pub. No.: US 2014/0192793 A1
(43) Pub. Date: Jul. 10, 2014

(54) SYSTEMS AND METHODS FOR HIERARCHICAL TIME SOURCE USAGE IN NEAR-ME AREA NETWORK DISCOVERY AND SYNCHRONIZATION

(71) Applicant: QUALCOMM Incorporated, San Diego, CA (US)

(72) Inventors: Santosh Paul Abraham, San Diego, CA (US); George Cherian, San Diego, CA (US)

(73) Assignee: QUALCOMM Incorporated, San Diego, CA (US)

(21) Appl. No.: 14/108,014

(22) Filed: Dec. 16, 2013

Related U.S. Application Data
(60) Provisional application No. 61/749,207, filed on Jan. 4, 2013.

(51) Int. Cl. H04W 8/00; H04W 76/02

(52) U.S. Cl. CPC H04W 8/005; H04W 76/02
USPC 370/338

(57) ABSTRACT

Methods, devices, and computer program products for hierarchical time source usage in near-me area network discovery and synchronization are described herein. In one aspect, a method for determining a discovery period using a hierarchy of external timing sources is provided. The method includes receiving an external timing signal from one or more external timing sources, and then using a hierarchy of external timing sources to determine which external timing source to use. The method further provides determining an offset from that external timing source, and using the external timing source and the offset to determine a discovery interval, in which to attempt to locate a near-me area network (NAN), such as a Social-WiFi network.

### CLAIM OF PRIORITY UNDER 35 U.S.C. §119

The present Application for Patent claims priority to Provisional Application No. 61/749,207 entitled “SYSTEMS AND METHODS FOR HIERARCHICAL TIME SOURCE USAGE IN NEAR-ME AREA NETWORK DISCOVERY AND SYNCHRONIZATION” filed Jan. 4, 2013, and assigned to the assignee hereof and hereby expressly incorporated by reference herein.

### BACKGROUND

1. Field

The present application relates generally to wireless communications, and more specifically to systems, methods, and devices for hierarchical time source usage in near-me area network discovery and synchronization.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

Devices in a wireless network may transmit and/or receive information to and from each other. To carry out various communications, the devices may need to coordinate according to a protocol. As such, devices may exchange information to coordinate their activities. Improved systems, methods, and devices for coordinating transmitting and sending communications within a wireless network are desired.

FIG. 1A illustrates an example of a wireless communication system 100. The wireless communication system 100 may operate pursuant to a wireless standard, such as an IEEE 802.11 standard. The wireless communication system 100 may include an AP 104, which communicates with STAs. In some aspects, the wireless communication system 100 may include more than one AP 104. Additionally, the STAs may communicate with other STAs. As an example, a first STA 106a may communicate with a second STA 106b. As another example, a first STA 106a may communicate with a third STA 106c although this communication link is not illustrated in FIG. 1A.

A variety of processes and methods may be used for transmissions in the wireless communication system 100 between the AP 104 and the STAs and between an individual STA, such as the first STA 106a, and another individual STA, such as the second STA 106b. For example, signals may be sent and received in accordance with OFDM/OFDMA techniques. If this is the case, the wireless communication system 100 may be referred to as an OFDM/OFDMA system. Alternatively, signals may be sent and received between the AP 104 and the STAs and between an individual STA, such as the first STA 106a, and another individual STA, such as the second STA 106b, in accordance with CDMA techniques. If this is the case, the wireless communication system 100 may be referred to as a CDMA system.

A communication link may be established between STAs. Some possible communication links between STAs are illustrated in FIG. 1A. As an example, a communication link 112 may facilitate transmission from the first STA 106a to the second STA 106b. Another communication link 114 may facilitate transmission from the second STA 106b to the first STA 106a.

The AP 104 may act as a base station and provide wireless communication coverage in a basic service area (BSA) 102. The AP 104 along with the STAs associated with the AP 104 and that use the AP 104 for communication may be referred to as a basic service set (BSS).

It should be noted that the wireless communication system 100 may not have a central AP 104, but rather may function as a peer-to-peer network between the STAs. Accordingly, the functions of the AP 104 described herein may alternatively be performed by one or more of the STAs.

FIG. 1B illustrates an example of a wireless communication system 160 that may function as a peer-to-peer network. For example, the wireless communication system 160 shown in FIG. 1B shows STAs 106a-i that may communicate with each other without the presence of an AP. As such, the STAs, 106a-i may be configured to communicate in different ways to coordinate transmission and reception of messages to prevent interference and accomplish various tasks. In one aspect, the networks shown in FIG. 1B may configured as a “near-me area network” (NAN), such as a Social-WiFi network. In one aspect, a Social-WiFi network may refer to a network for communication between STAs that are located in close proximity to each other. In some cases the STAs operating within the Social-WiFi network may belong to different network structures (e.g., STAs in different homes or buildings as part of independent LANs with different external network connections).

In some aspects, a communication protocol used for communication between nodes on the peer to peer communications network 160 may schedule periods of time during which communication between network nodes may occur. These periods of time when communication occurs between STAs 106a-i may be known as availability windows. An availability window may include a discovery interval or paging interval as discussed further below.

The protocol may also define other periods of time when no communication between nodes of the network is to occur. In some embodiments, nodes may enter one or more sleep states when the peer to peer network 160 is not in an availability window. Alternatively, in some embodiments, portions of the STAs 106a-i may enter a sleep state when the peer to peer network is not in an availability window. For example, some STAs may include networking hardware that enters a sleep state when the peer to peer network is not in an availability window, while other hardware included in the STA, for example, a processor, an electronic display, or the like do not enter a sleep state when the peer to peer network is not in an availability window.

The peer to peer communication network 160 may assign one node to be a root node. In FIG. 1B, the assigned root node is shown as STA 106e. In peer to peer network 160, the root node is responsible for periodically transmitting synchronization signals to other nodes in the peer to peer network. The synchronization signals transmitted by root node 160e may provide a timing reference for other nodes 106a-d and 106f-i to coordinate an availability window during which communication occurs between the nodes. For example, a synchronization message 172a-d may be transmitted by root node 106e and received by nodes 106b-c and 106f-g. The synchronization message 172 may provide a timing source for the STAs 106b-c and 106f-g. The synchronization message 172 may also provide updates to a schedule for future availability windows. The synchronization messages 172 may also function to notify STAs 106b-c and 106f-g that they are still present in the peer to peer network 160.

Some of the nodes in the peer to peer communication network 160 may function as branch synchronization nodes. A branch synchronization node may retransmit both availability window schedule and master clock information received from a root node. In some embodiments, synchronization messages transmitted by a root node may include availability window schedules and master clock information. In these embodiments, the synchronization messages may be retransmitted by the branch synchronization nodes. In FIG. 1B, STAs 106b-c and 106f-g are shown functioning as branch-synchronization nodes in the peer to peer communication network 160. STAs 106b-c and 106f-g receive the synchronization message 172a-d from root node 106e and retransmit the synchronization message as retransmitted synchronization messages 174a-d. By retransmitting the synchronization message 172 from root node 106e, the branch synchronization nodes 106b-c and 106f-g may extend the range and improve the robustness of the peer to peer network 160.

The retransmitted synchronization messages 174a-d are received by nodes 106a, 106d, 106h, and 106i. These nodes may be characterized as “leaf” nodes, in that they do not retransmit the synchronization message they receive from either the root node 106e or the branch synchronization nodes 106b-c or 106f-g.

Synchronization messages, or synchronization frames, may be transmitted periodically. This periodic transmission may allow devices on the network to sleep for times during which network transmissions are not being sent or received. However, a new device, which has not yet joined a network, may have to “listen” for synchronization or other discovery messages during a longer period of time, as a new device may not be aware of the timings provided by a synchronization message. This may consume a large amount of power. Thus, improved systems and methods for more efficient discovery of NANs, such as Social-WiFi networks, are desired.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include reduced power consumption when introducing devices on a medium.

In some aspects, a wireless device in an ad-hoc wireless communication network is disclosed. The device comprises a processor configured to determine a discovery interval, based at least in part on an offset and an external time based on a hierarchy of external timing sources and a receiver configured to scan for messages from a wireless network during the discovery interval.

In some aspects, the wireless device may include an offset based, at least in part, on an external timing source used to determine the external time. The offset may be predetermined. The hierarchy of external timing sources may be ordered based, at least in part, on an accuracy and/or a granularity of an external timing source. The hierarchy of external timing sources may include at least one of a time from a global positioning system (GPS) source, a time from a cellular network, and/or a time from an infrastructure access point (AP). The time from an infrastructure AP may comprise a time from a hierarchy of infrastructure APs. The hierarchy of external timing sources may be ordered: a time from a global positioning system (GPS) source, a time from a cellular network, and a time from a hierarchy of infrastructure APs. The hierarchy of infrastructure APs may be based, at least in part, on at least one of a wireless network name and/or a wireless network signal strength. The wireless device may include a sensor configured to detect when the wireless device is in motion, and the processor may be programmed to determine a discovery interval based, at least in part, on the motion of the wireless device. This sensor may be a GPS receiver and/or an accelerometer. The wireless device may include a transmitter which, if no messages are received during the discovery interval, transmits discovery packets and/or synchronization messages during the discovery interval. These discovery packets and/or synchronization messages may include an indication of an external timing source used to determine the discovery interval. The wireless device may determine a plurality of periodically-recurring discovery intervals, and may scan for messages during one or more of the plurality of periodically-recurring discovery intervals.

In some aspects, a method for using a hierarchy of timing sources to determine a discovery interval may be disclosed, the method comprising searching for external timing sources; if one or more external timing sources are found: ordering the one or more external timing sources based at least on a hierarchy; determining an offset; and calculating a discovery interval, based at least on the ordered external timing sources and the offset.

In some aspects, an apparatus for wireless communications may be disclosed, the apparatus comprising means for searching for external timing sources; if one or more external timing sources are found: means for ordering the one or more external timing sources based at least on a hierarchy; means for determining an offset; and means for calculating a discovery interval, based at least on the ordered external timing sources and the offset.

In some aspects, a non-transitory computer storage may be disclosed, the storage storing executable program instructions that direct a wireless communications device to perform a process that comprises searching for external timing sources; if one or more external timing sources are found: ordering the one or more external timing sources based at least on a hierarchy; determining an offset; and calculating a discovery interval, based at least on the ordered external timing sources and the offset.

### BRIEF DESCRIPTION OF THE DRAWINGS

FIG. 1A illustrates an example of a wireless communication system.

FIG. 1B illustrates another example of a wireless communication system.

FIG. 2 illustrates a functional block diagram of a wireless device that may be employed within the wireless communication system of FIG. 1A or 1B.

FIG. 3 illustrates an example of a communication system in which aspects of the present disclosure may be employed.

FIG. 4 is an illustration of a discovery window which may be used on a Social-WiFi network.

FIG. 5 is a flowchart illustrating an exemplary method to find a network using a hierarchical time source.

FIG. 6 is a flowchart of a method of using external time sources to synchronize time on a network.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Wireless network technologies may include various types of wireless local area networks (WLANs). A WLAN may be used to interconnect nearby devices together, employing widely used networking protocols. However, the various aspects described herein may apply to any communication standard, such as a wireless protocol.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device or wireless device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, a root node of a peer to peer network may transmit synchronization messages to coordinate one or more availability windows for communication between nodes of the peer to peer network. These synchronization messages may be transmitted on a fixed interval. For example, these synchronization messages may be transmitted once every 5, 10, 20, 50, or 100 availability windows. However, a fixed interval between synchronization messages may be problematic as too short an interval may result in unnecessary network overheard, while too long an interval may result in synchronization error due to clock drift. Thus, it may be beneficial to optimize the interval between synchronization messages in order to minimize synchronization errors while also minimizing unnecessary network overhead.

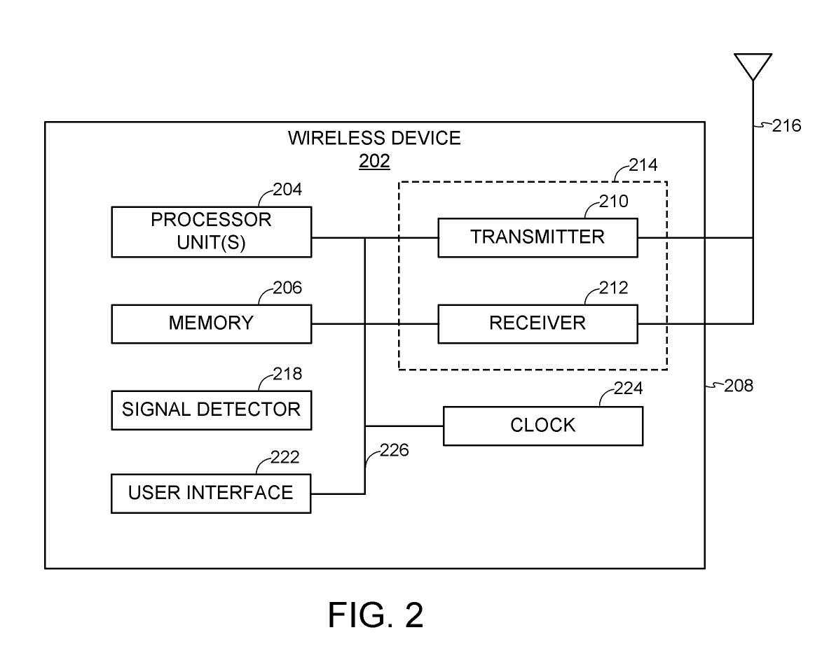

FIG. 2 illustrates various components that may be utilized in a wireless device 202 that may be employed within the wireless communication system 100 or 160. The wireless device 202 is an example of a device that may be configured to implement the various methods described herein. For example, the wireless device 202 may comprise the AP 104 or one of the STAs 106a-i.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. In addition, the wireless device 202 may include a clock 224 configured to generate a clock signal that is used to coordinate and synchronize activities of the wireless device 202. In some configurations, the processor 204 may include the clock 224. The processor 204 may be configured to update the clock with a time value to allow for synchronization with other wireless devices.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The transmitter 210 may be configured to wirelessly transmit packets having different packet types or functions. For example, the transmitter 210 may be configured to transmit packets of different types generated by the processor 204. When the wireless device 202 is implemented or used as an AP 104 or STA 106, the processor 204 may be configured to process packets of a plurality of different packet types. For example, the processor 204 may be configured to determine the type of packet and to process the packet and/or fields of the packet accordingly. When the wireless device 202 is implemented or used as an AP 104, the processor 204 may also be configured to select and generate one of a plurality of packet types. For example, the processor 204 may be configured to generate a discovery packet comprising a discovery message and to determine what type of packet information to use in a particular instance.

The receiver 212 may be configured to wirelessly receive packets having different packet types. In some aspects, the receiver 212 may be configured to detect a type of a packet used and to process the packet accordingly.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. The components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

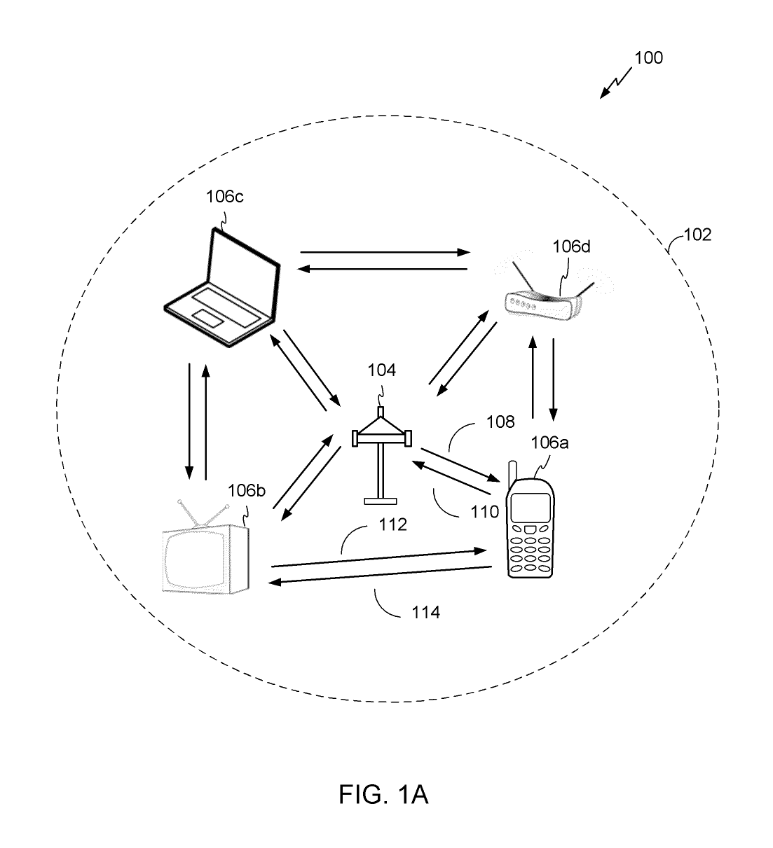

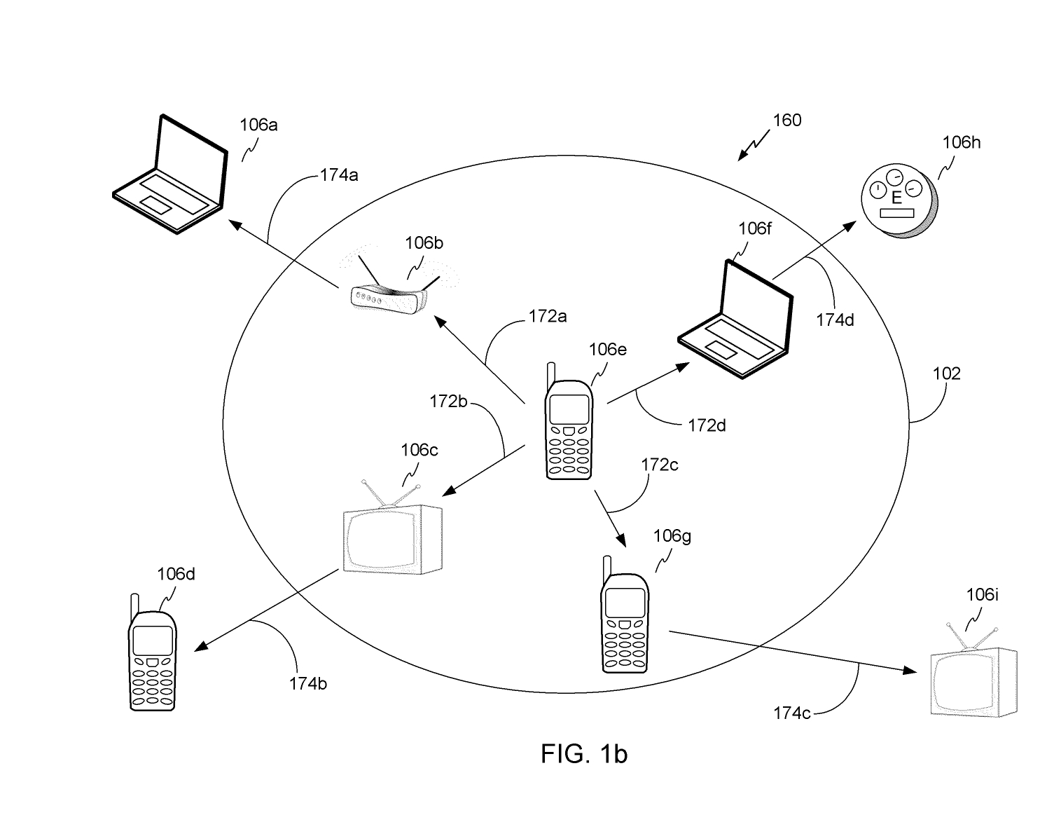

Devices, such as STAs, 106a-i shown in FIG. 1B, for example, may be used for Social-WiFi networking. For example, various stations within the network may communicate on a device to device (e.g., peer-to-peer communications) basis with one another regarding applications that each of the stations supports. A discovery protocol may be used in a Social-WiFi network to enable STAs 106 to advertise themselves (e.g., by sending discovery packets) as well as discover services provided by other STAs 106 (e.g., by sending paging or query packets), while ensuring secure communication and low power consumption.

In a Social-WiFi network, one device, such as wireless device 202, in the network may be designated as the root device or node. In some embodiments, the root device may be an ordinary device, like the other devices in the network, rather than a specialized device such as a router. In Social-WiFi network, the root node may be responsible for periodically transmitting synchronization messages, or synchronization signals or frames, to other nodes in the network. The synchronization messages transmitted by root node may provide a timing reference for other nodes to coordinate an availability window during which communication occurs between the nodes. The synchronization message may also provide updates to a schedule for future availability windows. The synchronization messages may also function to notify STAs that they are still present in the peer to peer network.

Each device in the network may have a clock, such as clock 224 in wireless device 202. This clock may be an internal clock, built in to the device when it was constructed. This clock may be configured to generate a clock signal that is used to coordinate and synchronize activities of the device. However, this clock may have some amount of clock drift, where clock drift may represent the difference between the clock signals generated by the clock and clock signals that may be generated by an ideal clock. This clock drift may be present in the clock of the root node as well as in clocks on branch nodes and leaf nodes in a Social-WiFi network.

Clock drift may be random, or may be constant to some extent. Clock drift may be expressed in a number of ways. For example, clock drift may be expressed as:

tₙ=(1+dₙ)t

where t is the actual time, tₙ is the time as measured on the nth wireless device, and dₙ is the clock drift of the nth wireless device. For example, dₙ may be 0.001, which would result in a clock that is 0.1% faster than an ideal clock. In this formula, dₙ may be either positive or negative, in order to represent a clock which is either too fast or too slow, respectively.

This formula may provide an approximation of clock drift. This approximation may be more or less accurate, depending upon the nature of the clock drift. For example, if clock drift is constant or nearly constant, this formula may provide a very accurate approximation of clock drift, as long as dₙ can be accurately calculated. If the clock drift of a given device is not constant, this formula may be much less accurate, however.

Clock drift may introduce a certain amount of synchronization error to the network. In a Social-WiFi network, devices on the network may use synchronization messages transmitted by a root device and retransmitted by branch devices in order to determine availability windows. During these availability windows, devices in the Social-WiFi network may be configured to transmit and/or receive messages from other devices on the network. At other times, devices, or portions of devices, on the Social-WiFi network may be in a sleep state. For example, a device on a Social-WiFi network, such as wireless device 202, may enter a sleep state based at least in part on synchronization messages received from a root node. In some embodiments, devices on a Social-WiFi network may enter a sleep mode, where one or more elements of the device may enter a sleep mode, rather than the entire device. For example, wireless device 202 may enter a sleep mode wherein the transmitter 210, receiver 212, and/or transceiver 214 may enter a sleep mode based on synchronization messages received on a Social-WiFi network. This sleep mode may enable a wireless device 202 to conserve power or battery life.

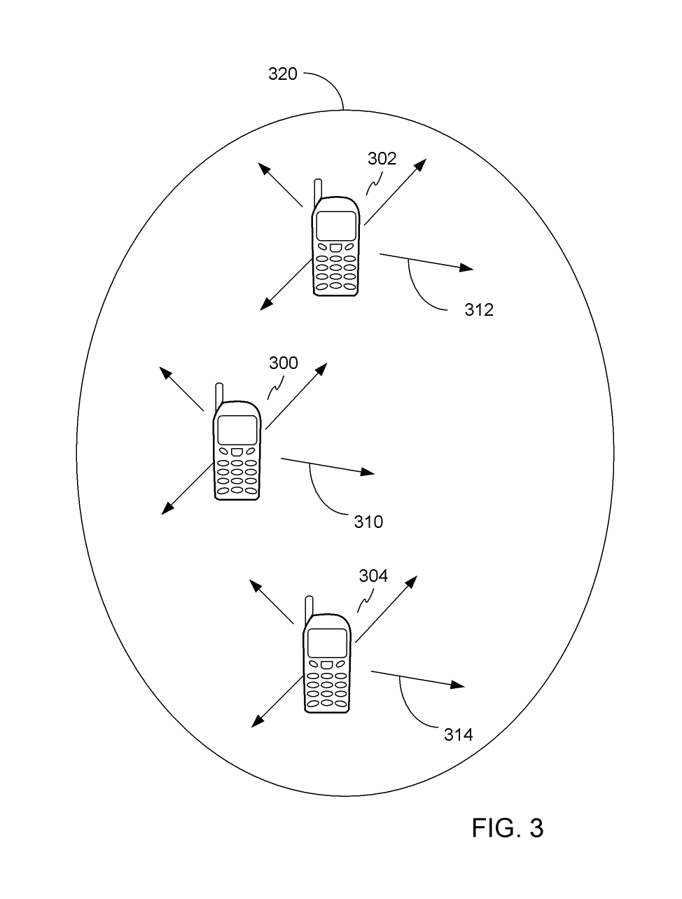

FIG. 3 illustrates an example of a communication system in which aspects of the present disclosure may be employed. Wireless device 300 may be a wireless device, such as wireless device 200. Wireless device 300 may be the root node of a peer-to-peer network, such as Social-WiFi network 320. Wireless device 300 may be configured to transmit messages 310 to other devices on the Social-WiFi network 320. As the root device, wireless device 300 may be configured to transmit synchronization messages on some interval to other devices on the Social-WiFi network 320.

Wireless devices 302 and 304 may be nodes on the Social-WiFi network 320. Wireless devices 302 and 304 may be branch nodes or leaf nodes on the network 320. As nodes on the Social-WiFi network 320, wireless devices 302 and 304 may transmit messages 312 and 314 to other devices on the network 320. These messages may be transmitted to other devices during an availability window, during which time each device is configured to transmit and/or receive transmissions from other wireless devices on the network 320. For example, wireless device 302 may transmit messages 312 to wireless device 304 during an availability window for both devices, where the availability windows is based in part upon a synchronization message received from wireless device 300.

Because devices on the Social-WiFi network 320 may have limited availability windows, a device that is not yet associated with a Social-WiFi network 320 (or any other NAN) may have some difficulty finding devices on the Social-WiFi network 320. It may be possible for such a device to continuously scan for messages from other devices, in order to discover a Social-WiFi network 320. However, such continuous scanning for messages may consume a large amount of power on a wireless device. This may be especially problematic if a wireless device may lose contact with a Social-WiFi network 320 frequently, as may be the case when a device is moving relative to other devices.

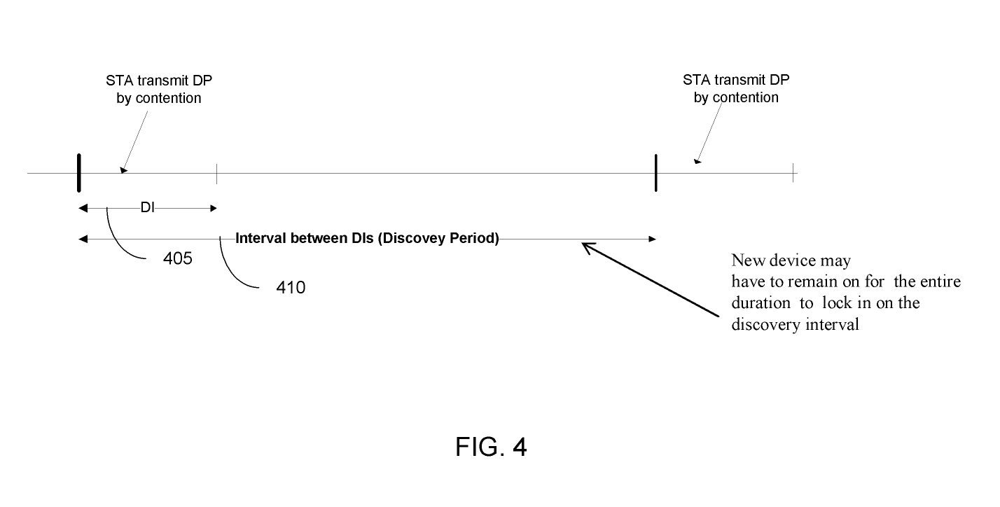

FIG. 4 is an illustration of a discovery window which may be used on a Social-WiFi network. A Social-WiFi network, such as Social-WiFi network 320, may have a discovery period 410. During this discovery period 410, there may be a discovery interval 405. The discovery interval 405 may be much shorter than the discovery period 410. When one discovery period 410 ends, a next discovery period 410 may begin. Thus, discovery intervals 405 may recur periodically.

During the discovery interval 405, wireless devices, or STAs, may transmit discovery packets or other messages. These discovery packets or other messages may be used in order for a wireless device to find a new network, such as a Social-WiFi network 320.

However, a discovery interval 405 may only occur once every discovery period 410. A discovery period 410 may be much longer than a discovery interval 405. For example, a discovery period 410 may be 1, 2, 5, 10 or 30 seconds. A wireless device that is not associated with a network may not know the timing of the discovery interval 405 and/or discovery period 410. Thus, without knowledge of when discovery intervals 405 may occur, a wireless device may need to scan for an entire discovery period 410 in order to discover Social-WiFi networks which are in range. It may be very power-intensive for a wireless device to scan for an entire discovery period 410. This may be especially problematic if a wireless device may have to frequently scan for new networks, such as, for example, if a wireless device is moving relative to other wireless devices. Thus, it may be desirable to provide a method for wireless devices to determine the times are which discovery intervals 405 may occur, in order to allow wireless devices to find new networks, such as Social-WiFi networks, more easily and with less power consumption.

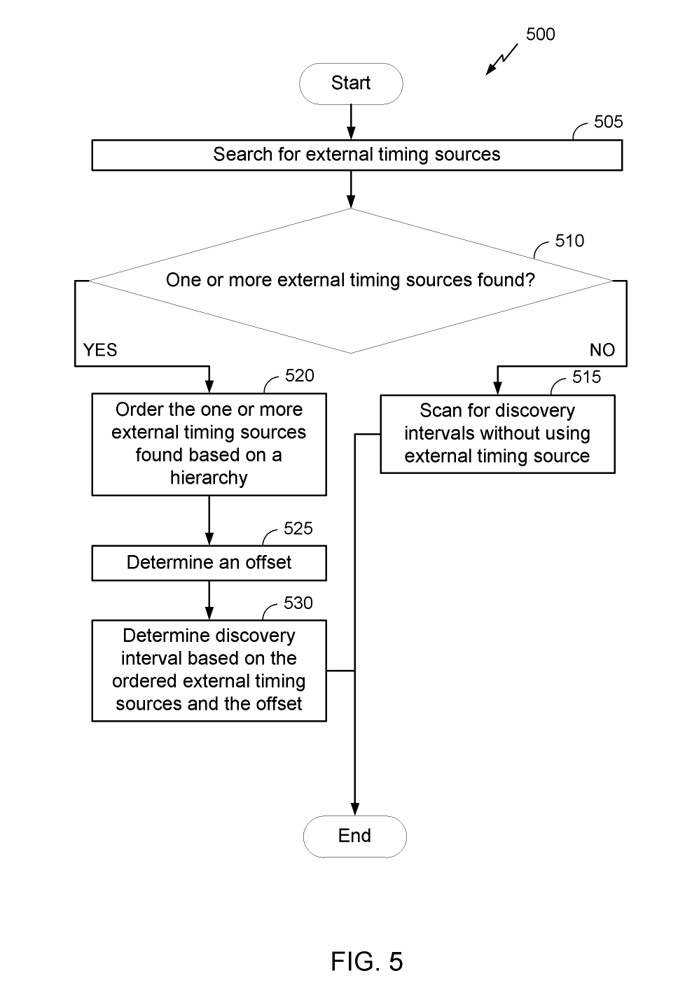

FIG. 5 is a flowchart illustrating an exemplary method to find a network, such as a Social-WiFi network, using a hierarchical time source. This method may be done by a wireless device, such as wireless device 202. In some aspects, wireless device 202 may be associated with a network and looking for other networks or may be looking for a network to associate with.

At block 505, wireless device 202 searches for external timing sources. External timing sources may be sources of time which wireless device 202 has access to and that other wireless devices may also have access to. External timing sources may be accurate sources of timing information. Accordingly, external timing sources may be useful to coordinate clocks with other devices, and may also be useful to coordinate discovery intervals with other devices. Possible external timing sources may include global positioning system (GPS) satellites, cellular or other land-based network sources such as WAN sources, or infrastructure APs such as APs for LANs which may be in the area. Other external timing sources may also be used, as may be available in the area, and which wireless device 202 may be capable of receiving timing information from.

At block 510, wireless device 202 determines how many external timing sources it was able to find. Wireless device 202 may be able to find a varying number of external timing sources, depending upon the environment, and the number of possible external timing sources that wireless device 202 is configured to connect to. For example, in some locations, such as inside buildings or in a subway, it may be more difficult to connect to certain external timing sources. Similarly, a varying number of APs for LANs may be in any given area.

At block 515, if wireless device 202 did not find any external timing sources, it scans for discovery intervals without using an external timing source. This may be done in any number of ways. For example, wireless device 202 may scan continuously for a discovery period or longer. Alternatively, wireless device 202 may select a random time, and may scan for a period of time beginning from the randomly-selected time. Other methods may also be used to find a wireless network when no external timing sources are found.

At block 520, if one of more external timing sources were found, the wireless device 202 orders the one or more external timing sources found based on a hierarchy, or a priority. For example, the wireless device 202 may come preprogrammed with a hierarchy of external timing sources. This hierarchy may define an order in which the wireless device 202 may depend upon external timing sources, in the instance where multiple external timing sources are found. This order may be based, at least in part, on factors such as the accuracy of the timing sources, the granularity of the timing source, and how widely available a timing source may be expected to be. For example, if the external timing sources are GPS, cellular towers, and infrastructure APs, the hierarchy may be ordered as GPS-based UTC time, cellular-based UTC time, and third-party timing sources that may be obtained locally, such as infrastructure AP timing. Within each of these broad categories, there may also be hierarchies of how to order timing sources. For example, if multiple infrastructure APs are found, these infrastructure APs may be ordered based, at least in part, on their signal strength, range, or their name. As such, a portion of the hierarchy of time sources may be ordered in terms of the strong to weak signal strengths, near to far ranges, or both. The hierarchy of time sources may be ordered as well based on the name of the source. In so far as a portion of the hierarchy of time sources may be ordered based on signal strength, range, or name, different wireless devices having similar wireless connectivity conditions in a Social-WiFi network would have a common or similar hierarchy of time sources. This hierarchy may represent an attempt to allow as many wireless devices as possible to use the same timings. This may allow the wireless devices, despite having no direct contact with each other initially, to time their discovery intervals and periods in similar ways, in order to allow the wireless devices to find each other while minimizing power consumption due to scanning for networks to join.

At block 525, the wireless device 202 determines an offset. An offset may represent an amount of time after a certain time when a discovery interval or other timing period may occur. For example, in some embodiments, an offset of 200 ms may be used. In this aspect, a discovery interval may occur every 5 seconds, and may occur 200 ms after each 5 second interval, such as 200 ms after times ending in 00 seconds, 05 seconds, and so on. The offset used may depend, at least in part, on the timing source used and/or the granularity of the timing source. For example, a different offset may be used for different timing sources, and may also depend upon how frequently various timing sources may transmit timing information. These offsets may dictate the alignment of the discovery period of a device relative to the timing source. These offsets may be pre-programmed into devices, and may be the same or different for each timing source.

At block 530, a wireless device 202 determines the discovery interval based on the ordered external timing sources and the offset. For example, the wireless device 202 may determine the time according to the highest-priority, or highest in the hierarchy, available external timing source, and may determine an offset for this external timing source. The wireless device 202 may then determine the discovery interval and discovery period timings based upon this external timing source. The wireless device 202 may then seek networks, such as Social-WiFi networks, during the discovery interval based on the ordered external timing sources and the offset. In some embodiments, if the wireless device 202 is unable to locate an existing Social-WiFi network, the wireless device 202 may be configured to become a root node of a new Social-WiFi network, and may be configured to transmit discovery packets and/or synchronization messages at a timing based on the external timing source and the offset.

This method may be beneficial, as it may allow wireless devices, such as wireless device 202, to find each other at common timings, despite not having initial contact with each other, and without having to scan continuously, which may require a large amount of power and may quickly drain the battery of a wireless device. This method may work best when each wireless device is able to connect to the same external timing sources. Thus, in some aspects, it may be beneficial to choose a hierarchy of external timing sources based, at least in part, on how likely other wireless devices are to be able to access a particular timing source. For example, GPS-based timing sources may be preferable to some other timing sources, as GPS-based timing sources may be available to the largest number of devices in a given area.

The method of FIG. 5 may be used when a wireless device 202 is not connected to a network. In one aspect, the method may also be used when a wireless device 202 is connected to a network, but the device senses that it is in motion. This may be beneficial to allow the wireless device to find a new network when it is moving, as it may otherwise move out of the range of its previous wireless network. A wireless device 202 may sense that it is moving in a number of ways. For example, the wireless device 202 may sense that is moving based, at least in part, on the measurements from a sensor, such as an accelerometer. In some aspects, the wireless device 202 may also sense that it is moving based upon GPS or other signals.

In some aspects, the wireless device 202 may be configured to turn off the external source of timing once it has found a Social-WiFi network, in order to conserve power. For example, it may be very power-intensive for a wireless device to remain connected to an external source of timing information, such as a GPS satellite. Thus, to preserve battery life in a wireless device, it may be beneficial to turn off the external source of power once a wireless network has been located. In some aspects, the wireless device 202 may be configured to only periodically check the external source of timing, and to use a built-in clock to maintain timing information based, at least in part, on the received timings from the external timing source. In some aspects, devices may also occasionally go back to an external timing source, in order to correct for their own internal clock drift.

In some embodiments, when a wireless device 202 acts as a root node, and bases the timing of synchronization messages and/or discovery packets on an external timing source, it may be beneficial to indicate within at least some of those packets the source of timing information. For example, a synchronization message may include information about what the timing is based on (such as a GPS timing source), and may include information such as when the last update from that external timing source occurred. In some embodiments, other devices on the network may also include the source of their timing information and the time of the last update in synchronization messages. It may be beneficial for wireless devices to use this information received from other devices to update their own internal clocks. For example, a wireless device may have last updated its clock a certain amount of time ago, based upon a GPS source. If that wireless device receives a message containing a time from the GPS source which was updated more recently, it may be beneficial for the wireless device to update its internal clock based on the more recently-updated time from the same timing source.

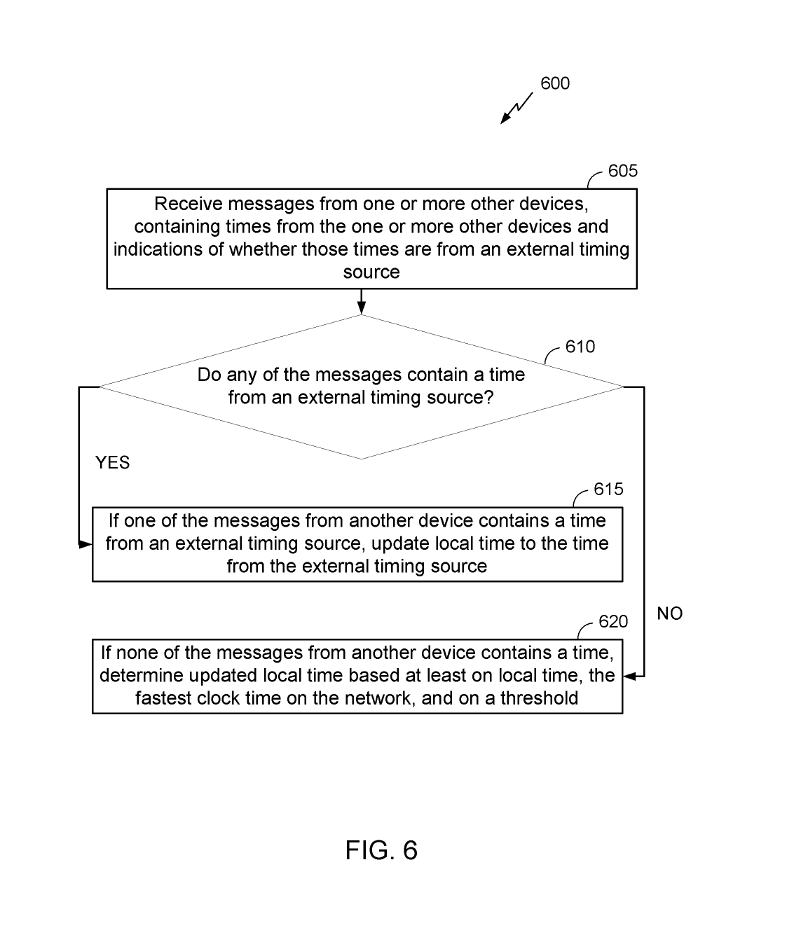

FIG. 6 is a flowchart of a method of using external time sources to synchronize time on a network. This method may be used by a wireless device, such as wireless device 202. In some aspects, this method may be done by a node on a wireless network, such as a Social-WiFi network, in order to synchronize the clocks of multiple devices on the wireless network. In some aspects, the wireless device 202 may include a local time, which may be used to determine when discovery intervals and other network timings may occur. This local time may include some amount of clock drift, and it may be beneficial to synchronize the local time with other times on the network and with external timing sources, if such sources are available.

At block 605, the wireless device 202 receives messages from one or more other devices, containing times from the one or more other devices and indications of whether those times are from an external timing source. These messages may comprise packets. These times may be contained in any type of message. The indication of whether the time is from an external timing source may comprise an indication of the external timing source used as well as an indication of how recently the time was received from the external timing source. In some aspects, a synchronization message from the root node may indicate an external timing source which is being used to time the discovery intervals of the network. In this aspect, the external timing source used for messages on the network may be that external timing source. In some aspects, this external timing source may be known to devices on the network, and may not be included in individual messages from devices on the network.

At block 610, the wireless device 202 determines whether any of the messages contain a time from an external timing source. In some aspects, the external timing source used may be the same as the external timing source used by the root node to determine discovery intervals and/or to time synchronization messages. In some aspects, a message may be thought of as being from an external timing source only if the message indicates the time from the external timing source is more recent than some threshold.

At block 615, if one of the messages from another device contains a time from an external timing source, the wireless device 202 updates its local time to the time from the external timing source. In some aspects, a message may be thought of as being from an external timing source only if the message indicates the time from the external timing source is more recent than some threshold. For example, if a time from an external timing source is older than some threshold, that time may be ignored. In some aspects, if multiple messages contain a time from an external timing source, the wireless device 202 may choose a time based on a priority, such as a hierarchy of external timing sources. The wireless device 202 may choose a time, based at least in part, on how recently a given time was updated, if such information is provided in a message. In some aspects, it may be desirable for the wireless device 202 to choose a time from a plurality of messages containing an external timing source in a deterministic manner, so that other wireless devices in the network may also choose the same time. This may be beneficial, as it may help wireless devices on the network to maintain similar times, and thus, may reduce synchronization error. For example, each wireless device 202 in a network may choose a time from the plurality of messages using the same method, and may choose the same time. Accordingly, the clocks on each of the wireless devices 202 in the network may be synchronized to the same time.

At block 620, if none of the messages from other devices contains a time, the wireless device 202 determines an updated local time based at least on local time, the fastest clock time on the network, and on a threshold. For example, the wireless device 202 may compare each time received from other devices on the network, in order to determine which time is the fastest. The wireless device 202 may then compare this time to its local time. The wireless device 202 may include a threshold, such as a drift threshold. This drift threshold may determine the maximum amount of drift that the wireless device 202 may have from the fastest time on the network before it may update its local time. In some aspects, the wireless device 202 may calculate and absolute value of the difference between its local time and the fastest time on the network, and compare this value to a drift threshold. If this difference is larger than the drift threshold, the wireless device 202 may set its local time to be that of the fastest time on the network. This may be beneficial, as it may allow more standardized times across devices on the network, which may reduce synchronization error.

It should be understood that any reference to an element herein using a designation such as “first,” “second,” and so forth does not generally limit the quantity or order of those elements. Rather, these designations may be used herein as a convenient wireless device of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-11 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A wireless device in an ad-hoc wireless communication network comprising:
a processor configured to determine a discovery interval, based at least in part on an offset and an external time based on a hierarchy of external timing sources; and
a receiver configured to scan for messages from a wireless network during the discovery interval.

2. The wireless device of claim 1, wherein the offset is based, at least in part, on an external timing source used to determine the external time.

3. The wireless device of claim 1, wherein the hierarchy of external timing sources is ordered based, at least in part, on an accuracy or a granularity of an external timing source.

4. The wireless device of claim 1, wherein the hierarchy of external timing sources includes at least one of a time from a global positioning system source, a time from a cellular network, a time from an infrastructure access point, a time from a hierarchy of infrastructure access points.

5. The wireless device of claim 4 wherein the hierarchy of infrastructure access points is based, at least in part, on at least one of a wireless network name and a wireless network signal strength.

6. The wireless device of claim 5, wherein the hierarchy of infrastructure access points is based on a wireless network signal strength, such that infrastructure access points are ordered from strong to weak signal strengths, or near to infrastructure far access points.

7. The wireless device of claim 1, further comprising a sensor configured to detect when the wireless device is in motion, and wherein the processor is further configured to determine a discovery interval based, at least in part, on the motion of the wireless device.

8. The wireless device of claim 7, wherein the sensor comprises one or more of a GPS receiver and an accelerometer.

9. The wireless device of claim 1, further comprising a transmitter configured to, if no messages are received during the discovery interval, transmit discovery packets or synchronization messages during the discovery interval.

10. The wireless device of claim 8, wherein the discovery packets or synchronization messages include an indication of an external timing source used to determine the discovery interval.

11. The wireless device of claim 1, wherein the processor is configured to determine a plurality of periodically-recurring discovery intervals, and the receiver is configured to scan for messages during one or more of the plurality of periodically-recurring discovery intervals.

12. A method for using a hierarchy of timing sources to determine a discovery interval, the method comprising:
searching for external timing sources;
if one or more external timing sources are found:
ordering the one or more external timing sources based at least on a hierarchy;
determining an offset; and
calculating a discovery interval, based at least on the ordered external timing sources and the offset.

13. The method of claim 12, wherein determining the offset comprises determining the offset based, at least in part, on the external timing sources found and the hierarchy.

14. The method of claim 12, wherein the hierarchy includes an ordered list of external timing source, the order based, at least in part, on an accuracy or a granularity of an external timing source.

15. The method of claim 12, wherein the hierarchy includes at least one of a time from a global positioning system source, a time from a cellular network, a time from an infrastructure access point, and a time from a hierarchy of infrastructure access points.

16. The method of claim 15, wherein the hierarchy of infrastructure access points is based, at least in part, on at least one of a wireless network name and a wireless network signal strength.

17. The method of claim 16, wherein the hierarchy of infrastructure access points is based on a wireless network signal strength, such that infrastructure access points are ordered from strong to weak signal strengths, or near to infrastructure far access points.

18. The method of claim 12, further comprising detecting when a wireless device is in motion, and wherein searching for external timing sources comprises searching for external timing sources based at least in part on the motion of the wireless device.

19. The method of claim 12, further comprising:
scanning for messages during the discovery interval; and
if no messages are received during the discovery interval, transmitting discovery packets or synchronization messages during the discovery interval.

20. The method of claim 19, wherein the discovery packets or synchronization message include an indication of an external timing source used to calculate the discovery interval.

21. The method of claim 12, wherein calculating a discovery interval comprises calculating a plurality of periodically-recurring discovery intervals.

22. An apparatus for wireless communications comprising:
means for searching for external timing sources;
if one or more external timing sources are found:
means for ordering the one or more external timing sources based at least on a hierarchy;
means for determining an offset; and
means for calculating a discovery interval, based at least on the ordered external timing sources and the offset.

23. The apparatus of claim 22, wherein means for determining the offset comprises means for determining the offset based, at least in part, on the external timing sources found and the hierarchy.

24. The apparatus of claim 22, wherein the hierarchy includes an ordered list of external timing source, the order based, at least in part, on an accuracy or a granularity of an external timing source.

25. The apparatus of claim 22, wherein the hierarchy includes at least one of a time from a global positioning system source, a time from a cellular network, a time from an infrastructure access point, and a time from a hierarchy of infrastructure access points.

26. The apparatus of claim 25, wherein the hierarchy of infrastructure access points is based, at least in part, on at least one of a wireless network name and a wireless network signal strength.

27. The apparatus of claim 26, wherein the hierarchy of infrastructure access points is based on a wireless network signal strength, such that infrastructure access points are ordered from strong to weak signal strengths, or near to infrastructure far access points.

28. The apparatus of claim 12, further comprising means for detecting when a wireless device is in motion, and wherein means for searching for external timing sources comprises means for searching for external timing sources based at least in part on the motion of the wireless device.

29. The apparatus of claim 12, further comprising:
means for scanning for messages during the discovery interval; and
means for transmitting discovery packets or synchronization messages during the discovery interval if no messages are received during the discovery interval.

30. The apparatus of claim 12, wherein means for calculating a discovery interval comprises means for calculating a plurality of periodically-recurring discovery intervals.
